(19) United States
(12) Patent Application Publication
(10) Pub. No.: US 2025/0127676 A1
(43) Pub. Date: Apr. 24, 2025

(54) HOLDER FOR A WALKING FRAME

(71) Applicants: Christine Clarke, Blandford Forum (GB); Bradley Buckingham, Blandford Forum (GB)

(72) Inventors: Christine Clarke, Blandford Forum (GB); Bradley Buckingham, Blandford Forum (GB)

(21) Appl. No.: 18/919,626

(22) Filed: Oct. 18, 2024

(30) Foreign Application Priority Data
Oct. 18, 2023 (GB) GB2315918.9

(51) Int. Cl. A61H 3/00

(52) U.S. Cl. CPC A61H 3/00; A61H 2003/004

(57) ABSTRACT

A holder configured for attachment to a mobility frame that has a crossbar at its upper part, the holder comprising an open-topped body, a tray at an upper part of the body, a plurality of pockets depending from the tray and opening into the tray, the configuration of the holder being such that, in use, at least some of the pockets engage opposite sides of the crossbar at the upper part of the mobility frame with the tray providing a support for plates.

### CROSS-REFERENCE TO RELATED APPLICATION

This claims the benefit of priority from Application No. GB2315918.9, filed Oct. 18, 2023, which is incorporated by reference in its entirety.

### FIELD

This invention relates to walking frames, and is concerned particularly with holders for walking frames, for holding various items.

### BACKGROUND

Walking frames, often referred to as walkers or mobility frames, are assistive devices designed to provide support and stability to individuals with mobility issues, such as the elderly or those recovering from injury or surgery. They come in various forms and can be customized with accessories like caddies or trays to enhance their functionality.

A basic walking frame typically consists of a lightweight, metal frame with handles, four legs and rubber tips for stability. Users grip the handles and use the walker to provide support while walking. Some walking frames are provided with two front wheels for smoother movement, and ease of use. A user moves the frame forward a short distance, then steps towards it, gripping the handles for support as they do so.

Rolling walking frames, or rollators, comprise a walking frame with four wheels, that allow a user to push them forward rather than lifting them with each step. Rollators offer greater manoeuvrability and are suitable for individuals with better upper body strength and balance.

Caddies or trays are optional accessories that can be added to walking frames to increase their functionality and convenience. A caddy is a basket or pouch attachment that can be fixed to the frame of a walker, typically to the crossbar. A caddy provides a storage space for personal items like bags, purses, or groceries. Caddies are typically made from durable fabric or plastic and come in various sizes and designs.

A tray for a walking frame typically comprises a flat surface that can be attached to the top of a walker, often at the crossbar, creating a stable platform for carrying items such as meals on a plate or in a bowl, books, or laptops. These trays are usually made from lightweight, easy-to-clean materials like plastic.

Caddies and trays provide a convenient way to allow a user to carry items without needing to hold them in their hands, making moving around easier and more stable. This helps to instill a feeling of independence, in that a user can perform tasks such as preparing meals and hot drinks, and transporting them to a place to sit.

Caddies and trays help users to keep their belongings organized and within reach, making them feel more in control. A tray can provide a stable platform for tasks such as transporting a meal on a plate, or a drink in a cup, reducing the risk of spills or accidents.

When choosing a caddy or tray for a mobility frame, it's essential to ensure that it is compatible with the specific model of walking frame. Some accessories are designed to fit particular brands or models only.

A mobility frame, when paired with a caddy or a tray, can greatly improve the quality of life for individuals with mobility challenges, allowing them to maintain their independence and perform daily activities with ease.

A typical walking frame comprises a lightweight frame of tubular metal, with legs that are height adjustable. The frame surrounds the front and sides of a user, and they grasp the top of the sides with their hands. The walking frame is pushed a short distance ahead of the user, where they then walk to it.

Typically, a user may wish to transport a plate of food from the kitchen to their dining table or chair, along with perhaps a drink. They may also wish to have their mobile phone within reach at all times, along with any emergency alarm systems, and other small items such as their glasses, and the remote control for the television. Existing caddies provides a trough to transport some of these items, but are not suitable for all. An existing caddy cannot transport a plate of food, for an example, nor a hot drink. They also do not help with organizing these items, so that they can be easily retrieved from within the trough. If a mobile phone or remote alarm system is required in an emergency, it may take some time to retrieve this from a caddy suspended from the walking frame.

Existing trays may help to transport a plate of food or even a hot drink, but the flat surface does little to stop lateral movement of these items when using the walking frame to move about. These trays do not provide much space to transport all of the other key items that users may wish to carry within reach at all times.

Users of mobility frames typically strive for independence. They want to be able to prepare and carry their own food and drink from the kitchen to the table or sofa. They wish to be able to do this without the assistance of a carer. Some users may use a clip-on tray, which goes some way towards allowing a plate of food or a drink to be transported. They provide a flat surface, sometimes with rubberised coating, to carry a plate and prevent some movement whilst being transported. Users may also make use of clip-on cup holders, or make their drinks in cups with lids, to prevent any spillages from happening. But whilst striving for independence, these users tend to want to live as normal a life as possible, and use their usual items, such as a china mug for a cup of tea.

There is a need to provide an accessory for a walking frame that helps a user to carry plated meals and hot drinks, alongside essential items that they like to have to hand, such as their glasses, mobile phone, emergency alarm and the remote control. There is a need to help to organise these essential items so that they are easily retrieved when required. There is a need to fit a wide range of walking frames, and to conveniently attach to said walking frames. There is a need to provide a flat carrying surface for plated meals, that prevents spillages.

The prior art shows a number of devices which attempt to address these needs in various ways.

GB 2 516 783 (Nottingham Rehab Ltd) discloses a combination mobility frame or walker and trolley, where the trolley incorporates a forwardly positioned, removable tray. This walker allows for some items to be carried about on the tray, but it does not provide support against lateral movement of say a plate of food, nor does it provide a suitable way of transporting small essential items such as glasses, a mobile phone or emergency alarm.

U.S. Pat. No. 4,184,618 (Jones) discloses an article carrying attachment for walkers that comprises a compartment sub-divided to accommodate various items and suspended from two or more hangers or hooks, that can be secured to a frame member of the walker. Whilst going some way towards organising smaller items that are typically carried about, this article carrying attachment would not help to support a plate of food or a hot drink.

Whilst the prior art appears to address the issue of giving the user of a walking frame some independence by providing a means of carrying items from place to place, it does not provide a way of carrying the full range of items that a user may wish to transport. Whilst some of the prior art incorporates means of helping to organise the items being transported, it does not organise and display these items to make them easily seen and grabbed as and when required. Whilst some of the prior art provides a flat surface on which to transport a plate, it does not provide much support for these items, and therefore does not go very far towards preventing spillages.

### BRIEF SUMMARY

Preferred embodiments of the present invention aim to provide an accessory for a mobility frame that provides support for a wide multitude of items that are likely to need to be transported from place to place, from a plate of hot food and a drink, through to a mobile phone, emergency alarm, glasses, and remote control. Preferred embodiments of the present invention also aim to provide a means of presenting said items, such that they can be easily seen and grasped. Preferred embodiments of the present invention also aim to provide an accessory that fits a wide range of mobility frames, whilst providing a cost-effective solution to a manufacturer.

According to a first aspect of the present invention there is provided a holder configured for attachment to a mobility frame that has a crossbar at its upper part, the holder comprising an open-topped body, a tray at an upper part of the body, a plurality of pockets depending from the tray and opening into the tray, the configuration of the holder being such that, in use, at least some of the pockets engage opposite sides of the crossbar at the upper part of the mobility frame with the tray providing a support for plates.

Preferably, said first and second pockets are arranged substantially parallel to one another and spaced from one another.

Preferably, a pair of said first pockets are arranged side by side.

Preferably, the first pockets extend to respective sides of the tray and a single second pocket is located centrally with respect to the pair of first pockets.

Each said first pocket may be deeper than the or each said second pocket.

The pockets may comprise an elongated rectangular prism shape.

Preferably, the tray is disposed below the top of the body.

The tray may be formed with at least one depending recess that forms a cup holder.

At least one of the pockets may be formed with a projection that, in use, engages a crossbar of the mobility frame.

The body and the tray may be formed with a curved projection to accommodate part of the rim of a plate.

The holder may comprise a one-piece moulding.

According to a further aspect of the present invention, there is provided a mobility frame that has a crossbar at its upper part and is provided with a holder as above.

### BRIEF DESCRIPTION OF THE DRAWINGS

For a better understanding of the invention and to show how embodiments of the same may be carried into effect, reference will now be made, by way of example, to the accompanying diagrammatic drawings, in which:

FIG. 1 shows one embodiment of a holder for a walking frame in isometric view from above, showing an open-topped body;

FIG. 2 shows the holder for a walking frame of FIG. 1 in isometric view from below, showing a plurality of pockets depending from the open topped body;

FIG. 3 shows a further isometric view of the holder of FIGS. 1 and 2, showing one embodiment of a rim with a plate-engaging curved projection;

FIG. 4 shows a further isometric view of the holder with one embodiment of crossbar-engaging pockets;

FIG. 5 shows the holder in rear view;

FIG. 6 shows the holder in front view;

FIG. 7 shows the holder in plan view;

FIG. 8 shows the holder in underside view;

FIG. 9 shows the holder in side view;

FIG. 10 shows the holder in other side view;

FIG. 11 shows the holder positioned for mounting on a walking frame; and

FIGS. 12 and 13 shows the holder mounted on the walking frame.

FIG. 13 shows the holder mounted on the walking frame.

### DESCRIPTION

In the figures like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied, or combined in different combinations, where practical.

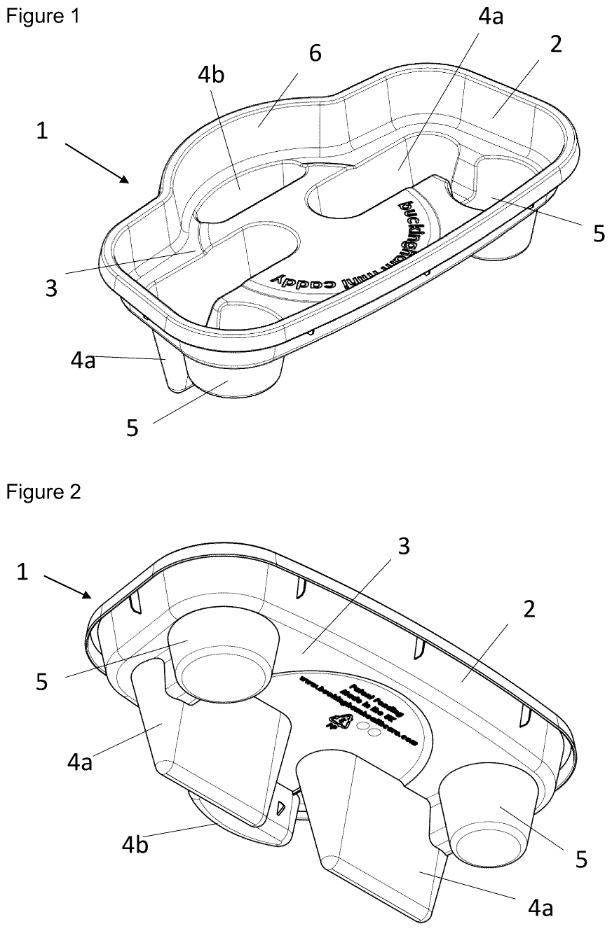

FIG. 1 shows an accessory for a mobility or walking frame that comprises a holder 1. The holder 1 comprises an open topped body 2, with a tray 3 positioned below the top of the body 2 and a plurality of pockets 4a, 4b depending from the tray 3. The holder 1 also incorporates a pair of cup holders 5 in the form of recesses that depend from the tray 3.

A user or carer for the user can secure the holder 1 to a crossbar of the walking frame, whereby the pockets 4a,b are configured to slide either side of the crossbar, gripping the crossbar therebetween. The holder 1 is mounted such that the tray 3, in use, is substantially flat. The rim of the body 2 and tray 3 comprise a curved projection 6 that is configured to support the edge of standard sizes of plate, thus inhibiting movement of a plate when placed on the tray 3.

The surface of the tray 3 may incorporate visual means to indicate where to place the plate on the surface to ensure that the curved projection 6 is made use of most effectively. When a plate is placed up against the curved projection 6, the plate would not move from side to side, thus helping to prevent spillages when moving the mobility frame from place to place.

FIG. 2 shows an underside view of the holder 1, showing one possible configuration of pockets 4a,b , with two first pockets 4a arranged side by side with a space between them and a single, second pocket 4b. The first pockets 4a extend to respective sides of the tray 3 and are located in a central area of the tray 3, from front to back of the tray 3. The single second pocket 4b is located centrally with respect to the pair of first pockets—that is, from side to side of the tray 3—and is located close to a front edge of the tray 3, adjacent to the curved projection 6.

The first pockets 4a in this configuration are deeper than the second pocket 4b. As shown in FIGS. 11 to 13, the holder 1 may be push fitted onto the crossbar 10 of a mobility frame 9, such that the pockets 4a,b sit either side of the crossbar 10 and the pockets 4a,b grip the crossbar 10.

The pockets 4a,b are of elongated, rectangular prism shape, being therefore substantially thin in configuration. The pockets 4a,b may resemble a rectangular box shape, characterized by having one dimension significantly smaller than the other two. As shown in the figures, the widths of the pockets 4a,b are substantially smaller than their length and depth. The corners and/or edges of said pockets 4 may be rounded.

The cup holders 5 may be identical in size, or may be of different sizes, as illustrated in the drawings. They may comprise different diameters and different depths to cater for different beverage containers, to ensure a good fit for the majority of these beverage containers. In a simplified option, the cup holders 5 may be apertures in the tray 3.

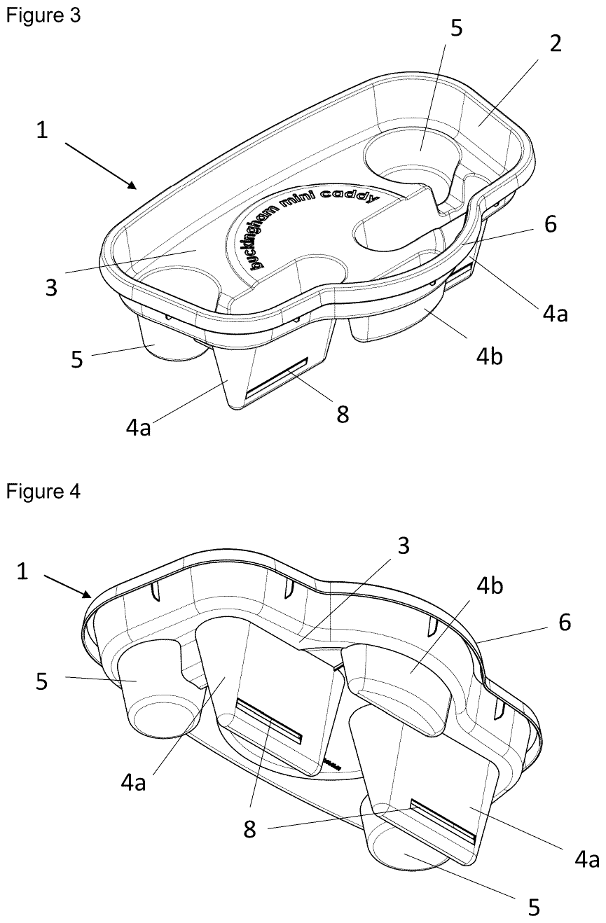

FIG. 3 shows a slot 8 within one of the pockets 4a through which an additional fastening clip may be mounted, not shown. The pockets 4a,b typically rest against a leg of the mobility frame, in use, and the slot 8 allows an additional fastening means to be used to secure the holder 1 to the mobility frame, preventing tip.

The pockets 4a,b are configured to accommodate a wide range of mobility frames, such that the gap between pockets 4a,b allows for both single crossbar and dual crossbar frames to be inserted. As illustrated, the pockets 4a,b are tapered, such that the side of the pockets 4a,b may rest against a number of different angled front legs of various models of mobility frame. This may ensure that the tray 3 of the holder 1 remains substantially flat when used with a wide range of different constructions of mobility frame. The pockets 4a,b may be stepped or staggered in shape, as an alternative or addition to tapered form.

FIG. 4 shows a slot 8 on each of the first pockets 4a that abuts a leg of the mobility frame. The pockets 4a,b may be of different shapes and sizes to allow for a user to organise and display different items that they wish to have on hand. They may wish to carry their mobile phone and emergency alarm in one pocket 4a,b , where they are easy to locate in an emergency situation or should they need assistance. They may wish to transport the television remote control, their glasses, a pen or other small items in another pocket 4a,b . The plurality of pockets 4a,b allows them to arrange their items according to their own needs and preferences.

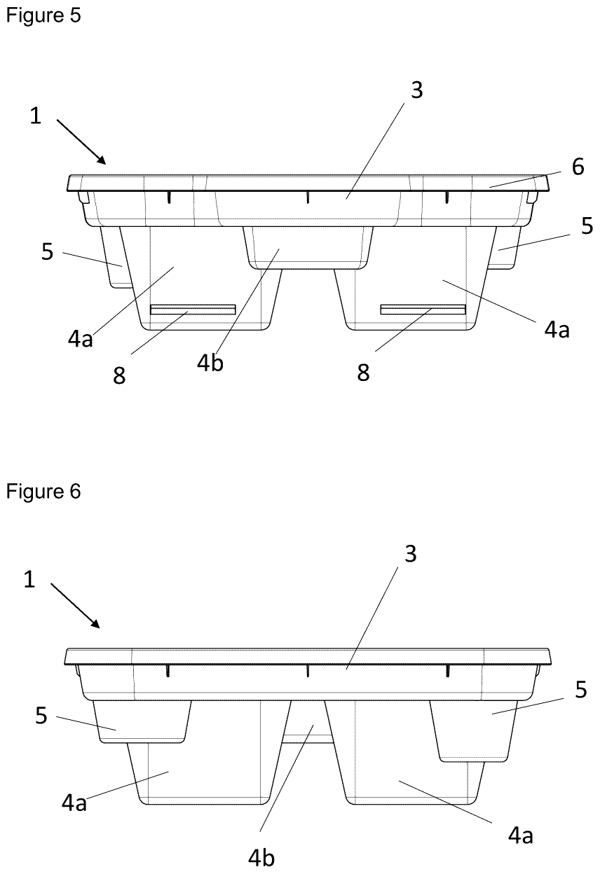

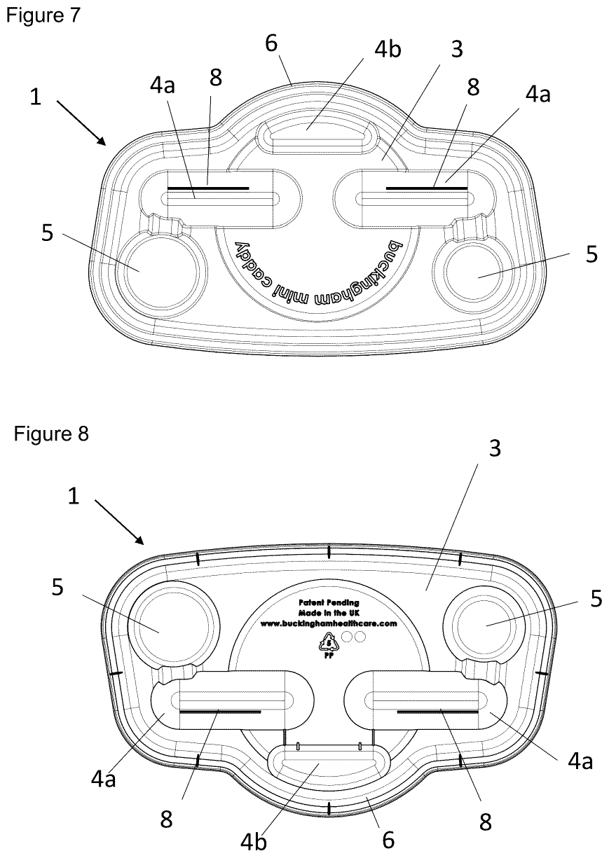

FIGS. 5 and 6 show one embodiment of differing depths of pockets 4a,b and cup holders 5. FIG. 7 shows a plan view of the holder 1 showing a symmetrical arrangement of pockets 4a. FIG. 8 shows an underside view showing the triangular arrangement of pockets 4a,b configured to mount to a crossbar in between. For some configurations of pockets 4a,b , a user may make use of one or more of these pockets 4a,b as handholds for stability, particularly when moving from a seated to standing position. The user may reach their hand into a pocket 4a,b to grip, and for leverage to help them to stand.

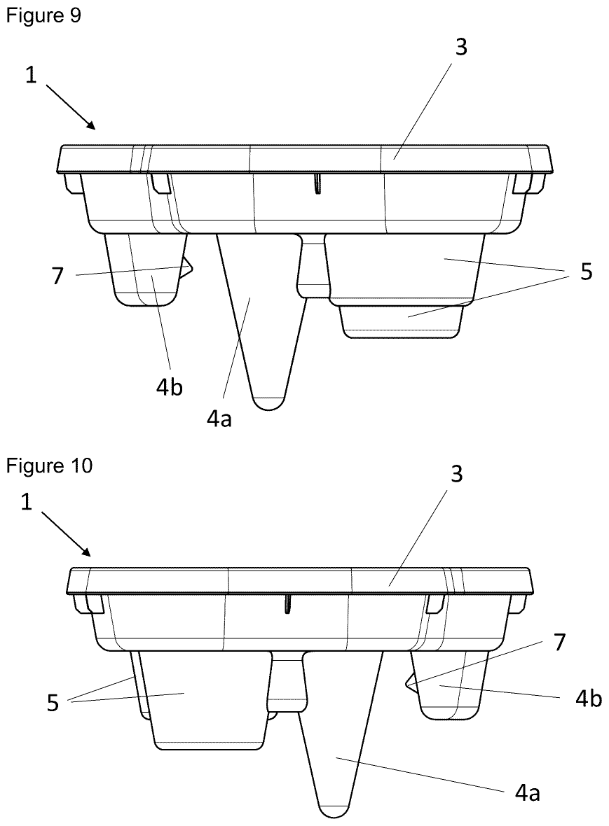

FIG. 9 shows a side view, with the pockets 4a,b depending from the open topped body 2 of the holder 1, and showing the tray 3, whereby the pocket 4b incorporates a crossbar engaging projection 7. This crossbar engaging projection 7 grips a crossbar in position, such that the tray 3 sits on the crossbar when mounted onto the walking frame, the crossbar of the walking frame sitting between the pockets 4a,b . The crossbar of a typical walking frame comprises tubular metal that has been bent into shape, and therefore the crossbar engaging projection 7 is configured to support a tubular member.

FIG. 9 shows that the spacing between first pockets 4a and second pocket 4b tapers towards the top of the holder 1. This assists location of the holder 1 as it engages with a crossbar of a mobility frame.

FIG. 10 shows a view of the holder 1 from the other side. A further function of the pockets 4a,b is to help prevent tip. By having pockets 4a,b , and in particular deep pockets 4a, the weight of the items being carried is placed lower down, and closer to the centre of gravity of the frame, when in use. In the example shown, the larger pockets 4a will be adjacent or about the main crossbar of a frame, and therefore this load is supported through the front legs of the frame, causing minimal tipping force of the frame.

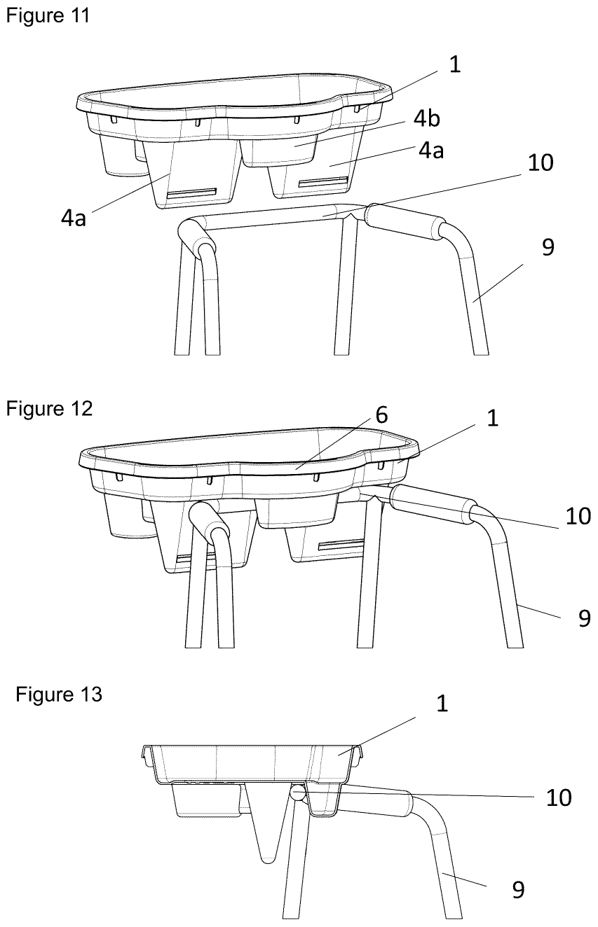

FIG. 11 shows one type of mobility frame 9, provided with a single crossbar 10 at the front, and a pair of hand grips on either side. The holder 1 is shown in position prior to being mounted to the crossbar 10. FIGS. 12 and 13 show the holder 1 when mounted to the crossbar 10 of the mobility frame 9, showing the pockets 4a,b sitting either side of the crossbar 10, with the tray 3 being held in a substantially horizontal configuration. The curved projection 6 is in a position closest to where a user of the mobility frame 9 would stand.

The holder 1 comprises an arrangement of pockets 4a,b that prevent the holder 1 from tipping forwards under load. The pockets 4a,b sit against the legs of the mobility frame 9 when subjected to heavier loads that cause the holder 1 to tip forwards, thus preventing any further tip. The deeper pockets 4a are located alongside the crossbar 10, and the curved projection 6 that provides guidance for where to place a plate is also located above the crossbar 10, thus ensuring that the majority of the load being carried by the holder 1 is directly supported by the legs of the mobility frame 9, preventing any unwanted torque.

The holder 1 may comprise a single piece, injection moulded from a plastics material. The holder 1 may incorporate various reinforcements within the mould for added strength to the plastic, such as about the lip or rim of the tray 3.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

That which is claimed is:

1. A holder configured for attachment to a mobility frame that has a crossbar at its upper part, the holder comprising an open-topped body, a tray at an upper part of the body, and a plurality of pockets depending from the tray and opening into the tray;
wherein, when the holder is attached to the mobility frame, at least some of the pockets engage opposite sides of the crossbar at the upper part of the mobility frame with the tray providing a support for plates.

2. The holder of claim 1, further comprising a first pocket and a second pocket that are arranged substantially parallel to one another and spaced from one another.

3. The holder of claim 2, further comprising a pair of first pockets arranged side by side.

4. The holder of claim 3, wherein the first pockets extend to respective sides of the tray and a single second pocket is located centrally with respect to the pair of first pockets.

5. The holder of claim 2, wherein the first pockets are deeper than the second pocket.

6. The holder of claim 1, wherein the pockets comprise an elongated substantially rectangular prism shape.

7. The holder of claim 1, wherein the tray is disposed below a top of the body.

8. The holder of claim 1, wherein the tray is formed with at least one depending recess that forms a cup holder.

9. The holder of claim 1, wherein at least one of the pockets is formed with a projection that engages the crossbar of the mobility frame when the holder is attached to the mobility frame.

10. The holder of claim 1, wherein the body and the tray are formed with a curved projection to accommodate part of a rim of a plate.

11. The holder of claim 1, wherein the holder further comprises a one-piece molding.

12. An apparatus comprising mobility frame that has a crossbar at its upper part and is provided with the holder of claim 1.
